(19) United States
(12) Patent Application Publication
(10) Pub. No.: US 2020/0191957 A1
(43) Pub. Date: Jun. 18, 2020

(54) TRANSMITTER HAVING BEAM-SHAPING COMPONENT FOR LIGHT DETECTION AND RANGING (LIDAR)

(71) Applicant: DiDi Research America, LLC, Mountain View, CA (US)

(72) Inventors: Youmin Wang, Berkeley, CA (US); Yonghong Guo, Mountain View, CA (US); Chao Wang, Milpitas, CA (US); Yue Lu, Los Gatos, CA (US); Lingkai Kong, Palo Alto, CA (US)

(73) Assignee: DiDi Research America, LLC, Mountain View, CA (US)

(21) Appl. No.: 16/224,776

(22) Filed: Dec. 18, 2018

(51) Int. Cl. G01S 17/08; G02B 27/30; G02B 27/09; H04B 10/50

(52) U.S. Cl. CPC G01S 17/08; G02B 27/30; H04B 10/503; G02B 27/0944; G02B 27/0972

(57) ABSTRACT

Embodiments of the disclosure provide transmitters for light detection and ranging (LiDAR). The transmitter includes a laser source configured to provide a plurality of native laser beams, and a light modulator configured to receive and modulate the plurality of native laser beams to form an output laser beam. The output laser beam includes a plurality of modulated laser beams. Each of the plurality of modulated laser beams has a chief ray. A first set of the chief rays on margins of the output laser beam are parallel to one another along an optical axis.

### TECHNICAL FIELD

The present disclosure relates to a Light Detection and Ranging (LiDAR) system, and more particularly to, a transmitter having a beam-shaping component for LiDAR.

### BACKGROUND

LiDAR systems have been widely used in autonomous driving and producing high-definition maps. For example, LiDAR systems measure distance to a target by illuminating the target with pulsed laser light and measuring the reflected pulses with a sensor. Differences in laser return times and wavelengths can then be used to make digital three-dimensional (3-D) representations of the target. The laser light used for LiDAR scan may be ultraviolet, visible, or near infrared. Because using a narrow laser beam as the incident light from the scanner can map physical features with very high resolution, a LiDAR system is particularly suitable for applications such as high-definition map surveys.

A LiDAR transmitter usually requires combining power from multiple laser diodes to meet the output power requirement. To reduce the number of laser diodes that are needed, multi-junction laser diodes can be used. However, the multi-junction pulsed laser diodes (PLDs) usually have gaps in between the light-emitting regions, thereby reducing the overall power density for the output beam. Moreover, it is too narrow to use conventional collimation techniques such as putting lens array to collimate each junction individually. Chief ray of each junction after traditional collimating lens will not be parallel to each other, which will worsen the beam propagation product (BPP) for the output beam.

Embodiments of the disclosure address the above problems by an improved transmitter having a beam-shaping component for LiDAR.

### SUMMARY

Embodiments of the disclosure provide a transmitter for LiDAR. The transmitter includes a laser source configured to provide a plurality of native laser beams, and a light modulator configured to receive and modulate the plurality of native laser beams to form an output laser beam. The output laser beam includes a plurality of modulated laser beams. Each of the plurality of modulated laser beams has a chief ray. A first set of the chief rays on margins of the output laser beam are parallel to one another along an optical axis.

Embodiments of the disclosure also provide a transmitter for LiDAR. The transmitter includes a multi-junction PLD configured to provide a first native laser beam in a first incident direction and a second native laser beam in a second incident direction different from the first incident direction. The transmitter also includes a light modulator. The light modulator includes a beam-shaping component that includes a transparent substrate and a light-shaping portion over the transparent substrate. The beam-shaping component is configured to selectively shape the first native laser beam and the second native laser beam and form a combined laser beam that includes chief laser beams from the first native laser beam and the second native laser beam. The chief laser beams are parallel to one another.

Embodiments of the disclosure also provide a transmitter for LiDAR. The transmitter includes at least three light-emitting regions in a multi-junction PLD. Each of the at least three light-emitting regions is configured to provide a respective native laser beam in a respective incident direction. The transmitter also includes a light modulator that includes a beam-shaping component. The beam-shaping component includes a transparent substrate and a light-shaping portion over the transparent substrate. The beam-shaping component is configured to selectively shape the at least three native laser beam and form a combined laser beam that includes chief laser beams from the at least three native laser beams. The chief laser beams are parallel to one another.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system having a transmitter with a beam-shaping component, according to embodiments of the disclosure.

FIG. 3A illustrates an exemplary multi-junction PLD, according to embodiments of the disclosure.

FIG. 3B illustrates a schematic diagram of a transmitter for LiDAR without a beam-shaping component.

FIG. 3C illustrates a far-field pattern of a combined laser beam without a beam-shaping component.

FIG. 4 illustrates a schematic diagram of an exemplary transmitter for LiDAR with a beam-shaping component, according to embodiments of the disclosure.

FIGS. 5A-5C each illustrates a far-field pattern with a beam-shaping component at a different location along an optical axis, according to embodiments of the disclosure.

FIG. 5D illustrates a far-field pattern of a combined laser beam with a beam-shaping component, according to embodiments of the disclosure.

FIGS. 6A-6D illustrate exemplary beam-shaping components, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

In the present disclosure, the fast axis is parallel to the z axis, the slow axis is parallel to the y axis, and the optical axis is parallel to the x axis. The z axis (e.g., the vertical axis) can be perpendicular to the x-y plane (e.g., the horizontal plane), and the x-axis and the y axis can be perpendicular to each other.

In the present disclosure, the term “incident direction” of a laser beam refers to the direction defined by the incident angle between the laser beam and the surface normal of the object the laser beam is incident on or exiting.

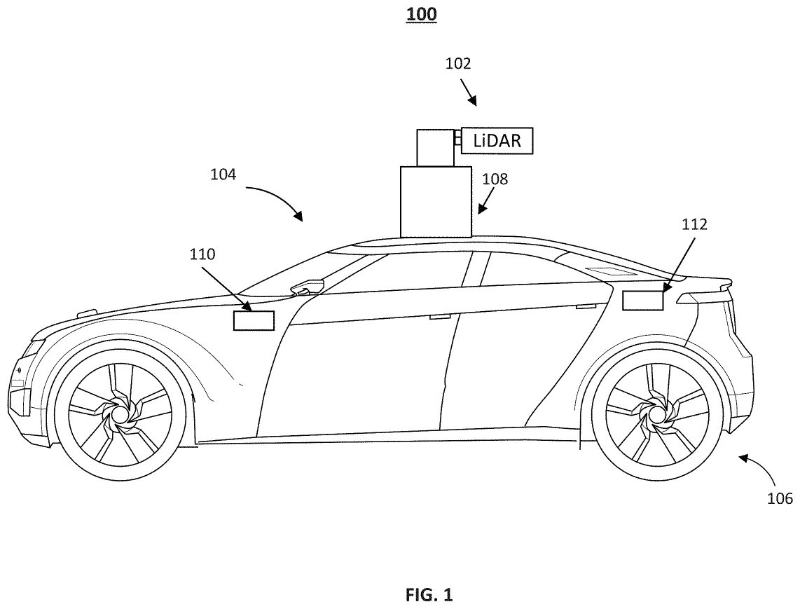

FIG. 1 illustrates a schematic diagram of an exemplary vehicle 100 equipped with a LiDAR system 102, according to embodiments of the disclosure. Consistent with some embodiments, vehicle 100 may be a survey vehicle configured for acquiring data for constructing a high-definition map or 3-D buildings and city modeling. It is contemplated that vehicle 100 may be an electric vehicle, a fuel cell vehicle, a hybrid vehicle, or a conventional internal combustion engine vehicle. Vehicle 100 may have a body 104 and at least one wheel 106. Body 104 may be any body style, such as a sports vehicle, a coupe, a sedan, a pick-up truck, a station wagon, a sports utility vehicle (SUV), a minivan, or a conversion van. In some embodiments of the present disclosure, vehicle 100 may include a pair of front wheels and a pair of rear wheels, as illustrated in FIG. 1. However, it is contemplated that vehicle 100 may have less wheels or equivalent structures that enable vehicle 100 to move around. Vehicle 100 may be configured to be all wheel drive (AWD), front wheel drive (FWR), or rear wheel drive (RWD). In some embodiments of the present disclosure, vehicle 100 may be configured to be operated by an operator occupying the vehicle, remotely controlled, and/or autonomous.

As illustrated in FIG. 1, vehicle 100 may be equipped with LiDAR system 102 mounted to body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3-D sensing performance.

Consistent with some embodiments, LiDAR system 102 and sensor 110 may be configured to capture data as vehicle 100 moves along a trajectory. For example, a transmitter of LiDAR system 102 is configured to scan the surrounding and acquire point clouds. LiDAR system 102 measures distance to a target by illuminating the target with pulsed laser light and measuring the reflected pulses with a receiver. The laser light used for LiDAR system 102 may be ultraviolet, visible, or near infrared. In some embodiments of the present disclosure, LiDAR system 102 may capture point clouds. As vehicle 100 moves along the trajectory, LiDAR system 102 may continuously capture data. Each set of scene data captured at a certain time range is known as a data frame.

As illustrated in FIG. 1, vehicle 100 may be additionally equipped with sensor 110, which may include sensors used in a navigation unit, such as a Global Positioning System (GPS) receiver and one or more Inertial Measurement Unit (IMU) sensors. By combining the GPS receiver and the IMU sensor, sensor 110 can provide real-time pose information of vehicle 100 as it travels, including the positions and orientations (e.g., Euler angles) of vehicle 100 at each time stamp. In some embodiments of the present disclosure, pose information may be used for calibration and/or pretreatment of the point cloud data captured by LiDAR system 102.

Consistent with the present disclosure, vehicle 100 may include a local controller 112 inside body 104 of vehicle 100 or communicate with a remote computing device, such as a server (not illustrated in FIG. 1), for controlling the operations of LiDAR system 102 and sensor 110. In some embodiments of the present disclosure, controller 112 may have different modules in a single device, such as an integrated circuit (IC) chip (implemented as an application-specific integrated circuit (ASIC) or a field-programmable gate array (FPGA)), or separate devices with dedicated functions. In some embodiments of the present disclosure, one or more components of controller 112 may be located inside vehicle 100 or may be alternatively in a mobile device, in the cloud, or another remote location. Components of controller 112 may be in an integrated device or distributed at different locations but communicate with each other through a network (not shown).

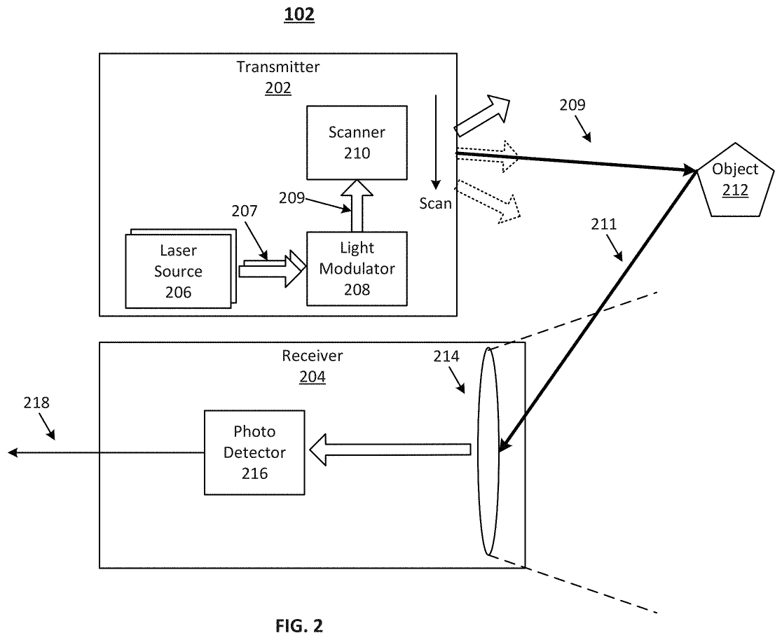

FIG. 2 illustrates a block diagram of an exemplary LiDAR system 102 having a transmitter 202 with a light modulator 208, according to embodiments of the disclosure. LiDAR system 102 may include transmitter 202 and a receiver 204. Transmitter 202 may emit laser beams within a scan angle. Transmitter 202 may include a plurality of laser sources 206, light modulator 208, and a scanner 210. Consistent with the disclosure of the present application, light modulator 208 can be included in transmitter 202 to spatially combine multiple laser beams provided by multiple laser sources 206 into a single combined laser beam and minimize the beam divergence in the combined laser beam based on beam shaping.

As described below in detail, light modulator 208 can change the irradiance and phase of light beams that are emitted by different laser sources 206 so the chief rays of light beams can be at least substantially parallel to one another after modulation. Accordingly, the far-field divergence of combined laser beam 209 can be reduced, thereby enhancing the overall power density of the output laser beam (e.g., combined laser beam 209.) In other words, the laser beams from multiple laser sources 206 can be combined without increasing the beam diameter or the beam propagation product (BPP) and thus, can be easily collimated onto the transmitter aperture of LiDAR system 102.

As part of LiDAR system 102, transmitter 202 can sequentially emit a stream of pulsed laser beams in different directions within its scan angle, as illustrated in FIG. 2. Each of multiple laser sources 206 may be configured to provide a native laser beam 207 in a respective incident direction to light modulator 208. In some embodiments of the present disclosure, each laser source 206 may generate a pulsed laser beam in the ultraviolet, visible, or near infrared wavelength range.

In some embodiments of the present disclosure, each of laser sources 206 includes a pulsed laser diode (PLD.) A PLD may be a semiconductor device similar to a light-emitting diode (LED) in which the laser beam is created at the diode's junction. In some embodiments of the present disclosure, a PLD includes a PIN diode in which the active region is in the intrinsic region, and the carriers (electrons and holes) are pumped into the active region from the N and P regions, respectively. Depending on the semiconductor materials, the wavelength of native laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm.

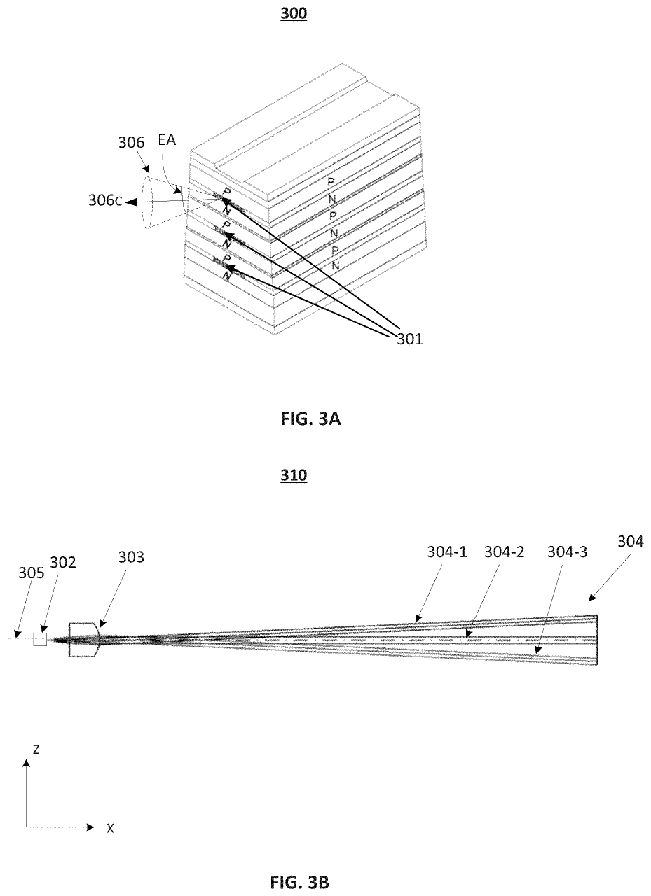

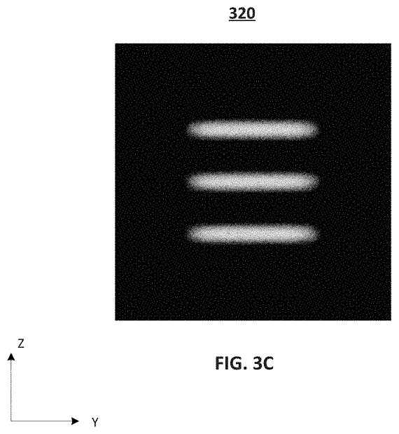

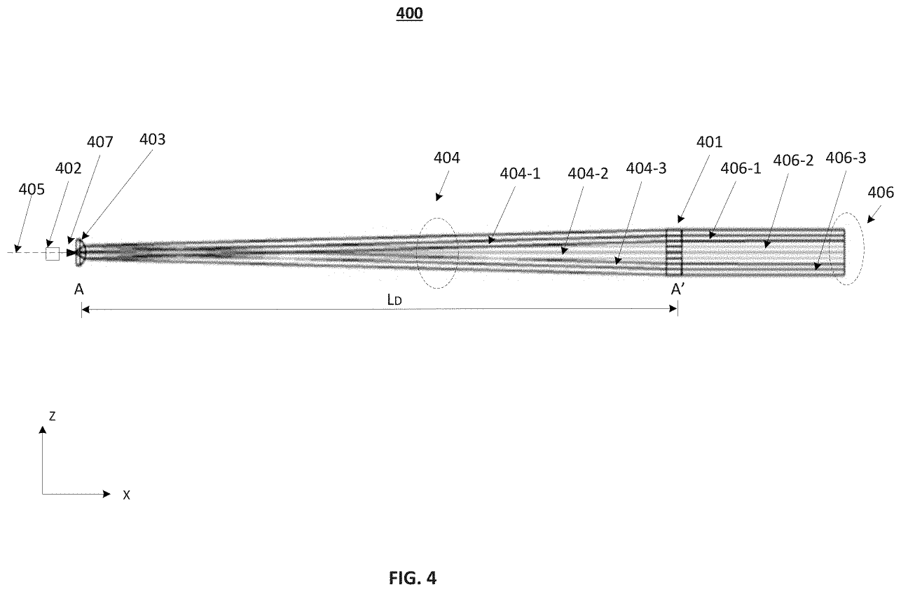

In some embodiments of the present disclosure, each of laser sources 206 includes a multi-junction PLD. A multi-junction PLD stacks multiple emitting junction areas into one laser diode. Ideally, the number of PLDs to be used to combine power into a higher power beam should be limited, to ease the alignment efforts and minimize assembly costs. This leads to the use of multi-junction PLDs as illustrated in FIG. 3A. Multi-junction PLD 300 illustrated in FIG. 3A includes a plurality of light-emitting regions 301. Each of light-emitting regions 301 is within one of multiple emitting PN diodes/junctions and can emit light. In some embodiments, light-emitting regions 301 may be equally spaced apart by gaps in a pitch, such as 5 μm. Light cannot be emitted from the gaps between light-emitting regions 301, which are reserved because of thermal control and process limitations. In other words, multi-junction PLD 300 may include interleaved light-emitting regions 301 and gaps. FIG. 3A illustrates a laser beam 306 (depicted as a cone with dashed lines) and a chief ray 306c of laser beam 306. Laser beam 306 can have a non-zero emission angle (depicted as EA). The gaps that separate light-emitting regions 301 can cause the chief ray of a native laser beam (i.e., the laser beams exiting the respective light-emitting regions 301 before collimation) to have a non-zero angle with another chief ray after collimator. This non-zero angle can lead to intersection of chief rays or the chief rays to be non-parallel to one another. In the present disclosure, the chief ray of a laser beam refers to the ray that starts at the edge of a respective light-emitting region 301 and passes through the center of the aperture stop (e.g., at the center of the cone angle of the emitted laser beam), which limits the amount of light passing through the collimator. That is, the chief ray crosses the optical axis of the collimator at the locations of the pupils, which are the images of the aperture stop.

Referring back to FIG. 2, in some embodiments, each laser source 206 is a multi-junction PLD 300 having interleaved light-emitting regions and gaps. This interleaved emitting configuration, however, lowers the output beam's spatial power density, while having the same BPP. As used in the present disclosure, BPP is the product of the system aperture size and the output beam divergence angle. In a small aperture LiDAR system, output beam divergence is fundamentally limited by BPP, which is dependent on the system aperture size, and the divergence angle of laser source 206. As described below in detail, laser source 206 may include one or more multi-junction PLDs configured to emit native laser beams 207 having chief rays of different incident directions (e.g., non-parallel directions.) Native laser beams 207 then enter or pass through light modulator 208 to be modulated into a combined laser beam 209. The modulated laser beams that form combined laser beam 209 may include chief rays (e.g., from native laser beams 207) that are at least substantially parallel to one another along the optical axis.

Light modulator 208 may be configured to receive native laser beams 207 from laser sources 206 in different incident directions and combine native laser beams 207 into combined laser beam 209 that propagates along the optical axis. In some embodiments of the present disclosure, light modulator 208 includes a collimator and a beam-shaping component configured to respectively collimate native laser beams 207 and shape the collimated laser beams, so combined laser beam 209 can have reduced far-field divergence. In some embodiments, light modulator 208 includes a beam-shaping component without a collimator.

To better illustrate the functions of light modulator 208, FIG. 3B illustrates a schematic diagram of an exemplary transmitter 310 for LiDAR without a beam-shaping component. Transmitter 310 includes one or more multi-junction PLDs 302 and one or more collimators 303, but no beam-shaping component. For ease of description, the one or more multi-junction PLDs 302 are represented by a triple-junction PLD, and the one or more collimators 303 are represented by a collimator 303. Multi-junction PLD 302 emits three native laser beams that transmit along optical axis 305 (e.g., the x axis) and the three native laser beams are collimated by collimator 303. The chief ray of each of the native laser beams after collimation is represented by the central line or the dashed line of the respective collimated laser beam (304-1, 304-2, and 304-3). Multi-junction PLD 302 can be the same as or similar to multi-junction PLD 300 illustrated in FIG. 3A. Light in laser beams 304-1, 304-2, and 304-3 is collimated and projected by collimator 303, such as a fast axis collimator (FAC), to make them substantially parallel to another.

The different native light beams emitted from multi-junction PLD 302 are projected/collimated by collimator 303 as thus multiplexed into a single combined laser beam 304, which includes a plurality of collimated laser beams. Each of the collimated laser beams is formed from the collimation of a respective native laser beam. The gaps between the light-emitting regions 301 of multi-junction PLD 302 still cause gaps in the collimated laser beams, which further causes the chief rays of the native laser beams to be non-parallel to one another and the chief rays of collimated laser beams (304-1, 304-2, and 304-3) to diverge from one another along the optical axis. As a result, combined laser beam 304 (similar to or the same as combined laser beam 209 of FIG. 2) undergoes beam divergence, causing the diameter and BPP of the combined laser beam to increase from those of individual native laser beams provided by multi-junction PLD 302. The output light density can thus be impaired or decreased.

FIG. 3C illustrates a far-field pattern 320 of a combined laser beam after collimation without a beam-shaping component. Far-field pattern 320 is recorded along optical axis 305 from a distance (e.g., far-field distance) that is sufficiently far from collimator 303. For example, the distance is about 2 m. As shown in FIG. 3C, the collimated laser beams diverge along the far axis (e.g., the x axis), causing the BPP and beam size of the combined laser beam to increase compared to those of individual native laser beams provided by multi-junction PLD 302.

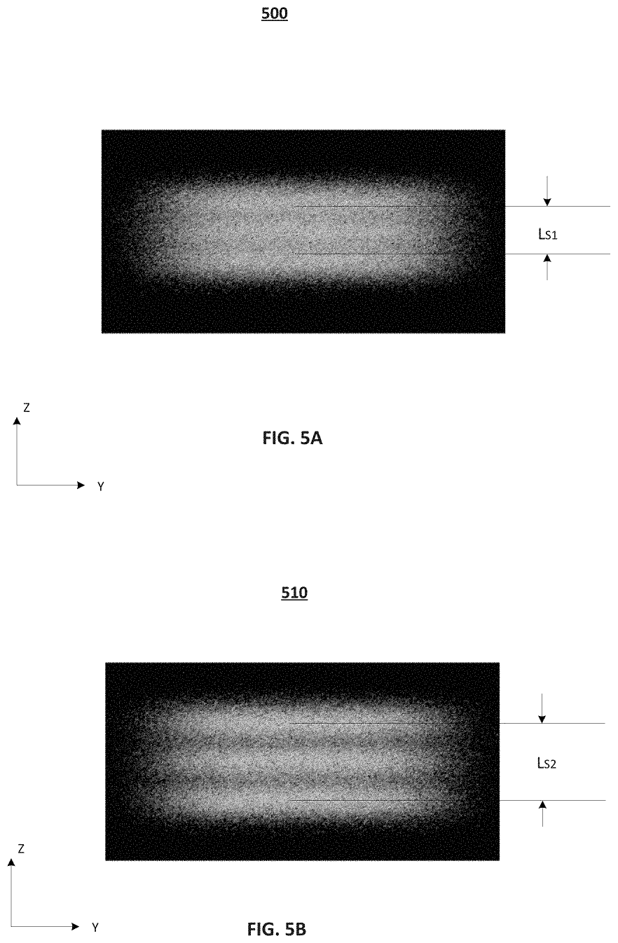

In contrast, FIG. 4 illustrates a schematic diagram of an exemplary transmitter 400 for LiDAR with a beam-shaping component, according to embodiments of the disclosure. Transmitter 400 may include a laser source 402, a collimator 403, and a beam-shaping component 401. In some embodiments of the present disclosure, laser source 402 includes interleaved light-emitting regions and gaps, similar to or the same as multi-junction PLD 300 illustrated in FIG. 3A. For example, laser source 402 may include a multi-junction PLD as shown in FIG. 3A. Collimator 403 may include a FAC that includes one or more aspheric cylindrical lenses and configured to project light beams from the light-emitting regions of laser source 402 into a respective incident direction.

For illustrative purposes, laser source 402 is described to include a triple-junction PLD that emits three native laser beams 407 (e.g., the laser beams before collimation by collimator 403); the native laser beams after collimation and before beam-shaping by beam-shaping component 401 are referred to as collimated laser beams 404-1, 404-2, and 404-3; and the collimated laser beams after beam-shaping are referred to as shaped laser beams 406-1, 406-2, and 406-3. The collimated laser beams can form a first combined laser beam 404, and the shaped laser beams can form a second combined laser beam 406. The chief ray is depicted as the central line of the respective laser beam (e.g., collimated laser beams 404-1, 404-2, and 404-3 and shaped laser beams 406-1, 406-2, and 406-3.) The chief ray of each collimated laser beam and each shaped laser beam is from the respective native laser beam.

Similar to or the same as multi-junction PLD 300 illustrated in FIG. 3A, laser source 402 may include three light-emitting regions, arranged from the top of laser source 402 to the bottom of laser source 402. The three light-emitting regions can be referred to as the top light-emitting region, the middle light-emitting region, and the bottom light-emitting region. The top light-emitting region can be positioned above an optical axis 405 along the z axis, the bottom light-emitting region can be positioned below optical axis 405 along the z axis, and the middle light-emitting region can be positioned between the top light-emitting region and the bottom light-emitting region (e.g., substantially in a middle position between the top light-emitting region and the bottom light-emitting region.) The native laser beam from each light-emitting region can have an EA of, e.g., about 40 degrees. The native laser beams from the top light-emitting region and the bottom light-emitting region can each pass through optical axis 405 and undergo collimation by collimator 403.

As shown in FIG. 4, the native laser beam from the top light-emitting region can be collimated to form collimated laser beam 404-3, and the respective chief ray can be the bottommost chief ray of first combined laser beam 404; and the native laser beam from the bottom light-emitting region can be collimated to form collimated laser beam 404-1, and the respective chief ray can be the topmost chief ray of first combined laser beam 404. For ease of description, the topmost and bottommost chief rays of first combined laser beam 404 can be referred to as chief rays on the margins of first combined laser beam 404. In some embodiments, chief ray of collimated laser beam 404-2 is non-parallel to at least one of collimated laser beams 404-1 and 404-2. The chief rays of the collimated laser beams can start to diverge along optical axis 405 from a distance after exiting collimator 403.

In the present disclosure, the angle between the chief rays on the margins of first combined laser beam 404 is assumed to be the greatest compared to any other angle between non-marginal chief rays. The disclosure is then described in view of the shaping of the chief rays on the margins of first combined laser beam 404 (e.g., the combined laser beam after collimation and before beam-shaping.) The chief rays between the chief rays on the margins of first collimated chief ray, such as the chief ray of the middle light-emitting portion, can be shaped in a similar manner according to the embodiments of the present disclosure. In the present disclosure, the disclosed optical device/component and method to shape an incident laser beam with non-parallel chief rays should not be limited by the embodiments of the present disclosure. For example, the number of light-emitting regions can be at least three, and the greatest angle shaped by the disclosed optical device/component can be exemplified to be but is not limited by the angle between the incident directions of the native laser beams from the topmost and bottommost light-emitting regions of the multi-junction PLD.

Beam-shaping component 401 may be configured to change the incident directions of the non-parallel chief rays of collimated laser beams 404-1 and 404-3 based on the angle therebetween. Beam-shaping component 401 can include a beam-shaping component or device that redistributes the irradiance and phase of laser beams. Beam-shaping component 401 can be made from a suitable material that has a sufficiently high light transmission rate (e.g., a transparent material.) Beam-shaping component 401 can be placed (at location A′ on optical axis 405) away from collimator 403 (at location A on optical axis 405) by a distance L_{D} along optical axis 405 to allow the non-parallel chief rays to pass through. Beam-shaping component 401 can redistribute the irradiance and phase of collimated laser beams 404-1 and 404-3 at various locations along optical axis 405 so the non-parallel marginal chief rays of first combined laser beam 404 (e.g., chief rays of collimated laser beams 404-1 and 404-3) can be substantially parallel to one another along optical axis 405 after beam-shaping. In some embodiments, beam-shaping component 401 can be placed at various locations along optical axis to provide different phase change and irradiance change so each chief ray in first combined laser beam 404 can be shaped to be substantially parallel to optical axis 405 when exiting from beam-shaping component 401. The BPP of second combined laser beam 406 can then be minimized. In some embodiments, the BPP of the second combined laser beam is close to (equal to or slightly higher than) the BPP of each of collimated laser beams without beam-shaping component 401 (e.g., BPP of each of collimated laser beams 304-1, 304-2, and 304-3), but much lower than combined beam without beam-shaping component 401.

The beam-shaping process can be described as follows. Assuming the angle between the chief rays on the margins of first combined laser beam 404 (e.g., the chief rays of collimated laser beams 404-1 and 404-3 respectively) is θ, and the beam size (i.e., projection of beam diameter along the fast axis) after collimation by is D (at location A) along the fast axis (e.g., the z axis), then distance L_{D} between beam-shaping component 401 and collimator 403 may be calculated as D/tan(θ). In some embodiments, considering actual operating condition of beam-shaping component 401 (e.g., the focal length of collimator 403, the properties of laser source 402, environmental error, and/or the manufacture deviations), distance L_{D} can be optimized (or tuned) based on the calculated value to obtain the smallest BPP. In some embodiments, L_{D} can be greater than the calculated value. In some embodiments, the optimized location of beam-shaping component 401 (e.g., the location that yields the minimum BPP or minimum beam size of second combined laser beam 406 along the fast axis) can be determined by adjusting location A′ of beam-shaping component 401 until the minimum BPP or minimum beam size of second combined laser beam 406 is obtained.

In some embodiments, laser source 402 includes at least three light-emitting regions, which are configured to emit at least three native laser beams. The chief rays on the margins of first combined laser beam 404 (e.g., form the native laser beams of the topmost and the bottommost light-emitting regions of light source 402) can be non-parallel to each other. In some embodiments, one or more of the chief rays between the chief rays on the margins are non-parallel to one or more of the chief rays on the margins. In some embodiments, chief ray of each of the collimated laser beams are non-parallel to one another. Beam-shaping component 401 can selectively redistribute the irradiance and phase of each collimated laser beam (e.g., 404-1, 404-2, and 404-3) based on, e.g., the beam size of each collimated laser beam when exiting collimator 403 (at location A), distance between beam-shaping component 401 and collimator 403, and/or incident angle of each collimated laser beam (e.g., the angle between the collimated laser beam and the surface normal of beam-shaping component 401), so that the chief rays of the corresponding shaped laser beams can be substantially parallel to one another. That is, the chief rays in second combined laser beam 406 can be parallel to one another.

In an example, the angle between the chief rays on the margins of first combined laser beam 404 (e.g., the chief rays of collimated laser beams 404-1 and 404-3) is about 0.43 degrees, and the beam size of each one of collimated laser beams 404-1 and 404-3 is about 400 μm. Distance L_{D} can be calculated to be 400 μm/tan(0.43°), which is 53 mm. In some embodiments, the calculated value of L_{D} (e.g., referred to as “calculated L_{D}”) is utilized as a base for determining the actual value of LD (e.g., referred to as “actual LD”) considering the actual operating condition of beam-shaping component 401. For example, beam-shaping component 401 can be moved closer to collimator 403 (e.g., to result in a smaller actual L_{D}) or farther away from collimator 403 (e.g., to result in a larger L_{D}) to obtain desired BPP or beam sizes of second combined laser beam 406 or shaped laser beams (e.g., 406-1, 406-2, and 406-3). For example, actual L_{D} can be about 10 mm to about 30 mm greater than the calculated L_{D}. In some embodiments, actual L_{D} is about 20 mm greater than the calculated L_{D}.

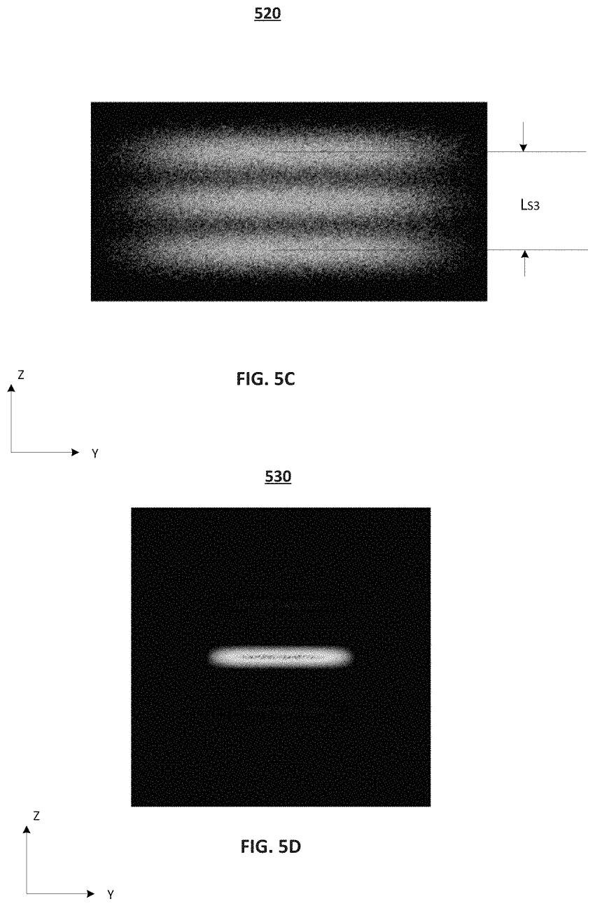

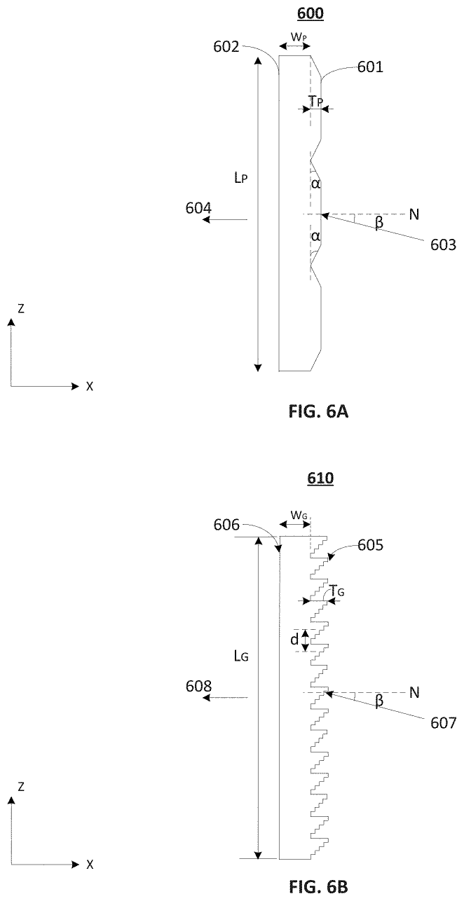

FIGS. 5A-5C illustrate far-field patterns 500, 510, and 520 of second combined laser beam with an exemplary beam-shaping component placed at a different location from the collimator in a transmitter similar to or the same as the transmitter illustrated in FIG. 4, according to embodiments of the present disclosure. Far-field patterns of second combined laser beams, which reflect the beam size of each shaped laser beam that forms the respective second combined laser beam can be recorded when the shaped laser beams exit the beam-shaping component at location A′ (e.g., the far-field distance being sufficiently small or close to zero), as shown in FIGS. 5A-5C. In this embodiment, the angle between the chief rays on the margins of first combined laser beam is about 0.43 degrees, and the beam size of each one of collimated laser beams is about 400 μm when exiting the collimator. According to the embodiments of the present disclosure, calculated L_{D} is 400 μm/tan(0.43°), which is 53 mm. FIG. 5A illustrates an image of beam sizes of each shaped laser beam when actual L_{D} is about 40 mm; FIG. 5B illustrates an image of beam sizes of each shaped laser beam when actual L_{D} is about 53 mm, and FIG. 5C illustrates an image of beam sizes of each shaped laser beam when actual L_{D} is about 66 mm. In some embodiments, the projections of shaped laser beams of a respective second combined laser beam are substantially evenly distributed along the fast axis (e.g., the z axis).

As shown in FIGS. 5A-5C, separation distance L_{Sn} (n=1, 2, 3) between the chief rays of the two laser beams (depicted as the distance between the centers of the projected patterns of the two laser beams) decreases when actual L_{D} is less than the calculated L_{D}, and increases when actual L_{D} is greater than calculated L_{D}. For example, L_{S1}<L_{S2}<L_{S3}, where L_{S2} represents the separation distance between the two chief rays on the margins of the second combined laser beam when the distance between the beam-shaping component and the collimator is equal to calculated L_{D}. In some embodiments, the separation distance stays substantially the same as L_{S3} when actual L_{D} keeps increasing from about 66 nm. In some embodiments, the far-field BPP of second combined laser beam can be minimized (or optimized) at the value of actual L_{D} that yields the largest separation distance (e.g., L_{S3} of the present embodiment.)

FIG. 5D illustrates a far-field pattern 530 of a second combined laser beam with a beam-shaping component, according to the embodiments of the present disclosure. The beam-shaping component can be the same as or similar to beam-shaping component 401 illustrated in FIG. 4, and distance L_{D} between the beam-shaping component and the collimator can be optimized by adjusting the location of the beam-shaping component along the optical axis so the far-field pattern of the second combined laser beam (i.e., the combined laser beam after collimation and beam-shaping) has a minimized pattern/beam size. Accordingly, the BPP of the second combined laser beam can be minimized or optimized. In an example, the far-field distance is about 2 m. In some embodiments, the far-field distance is any suitable distance between scanner 210 and object 212, referring back to FIG. 2. Compared to the far-field pattern illustrated in FIG. 3D (e.g., the far-field pattern yielded without utilizing a disclosed beam-shaping component), far-field pattern 530 (e.g., the far-field pattern yielded utilizing a disclosed beam-shaping component) is less divergent along the far axis (e.g., the z axis). Thus, the second combined laser beam (e.g., similar to or the same as output beam 209 in FIG. 2) can have decreased output divergence and power loss, improving the BPP of the second combined laser beam (or combined laser beam 209 in FIG. 2.)

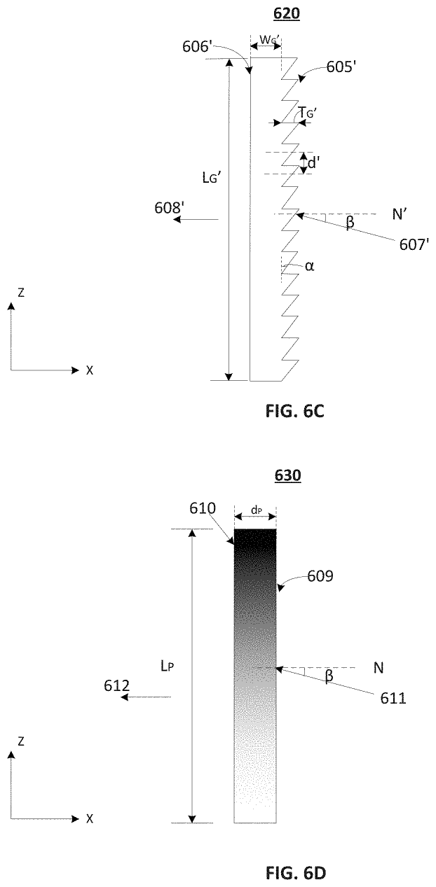

Beam-shaping component 401 can include any suitable optical device/component that can shape, deflect, and/or redistribute irradiance and phase of the incident laser beam (e.g., first combined laser beam 404.) FIGS. 6A-6C illustrate exemplary optical devices/components that can be included in beam-shaping components 401 for shaping the incident laser beam. The non-parallel chief rays in the incident laser beam can be shaped so the chief rays in the combined laser beam can be substantially parallel to one another after beam-shaping. FIGS. 6A-6C illustrate exemplary optical devices/components 600, 610, and 620 that can be used as beam-shaping component 401, according to embodiments of the present disclosure. In various embodiments, beam-shaping component 401 can include one or more of optical devices/components 600-620, and the one or more optical devices/components 600-620 can be the same or different. The locations of the one or more optical devices/components 600-620 can be adjusted to redistribute the irradiance and phase of the collimated laser beams that form the incident laser beam so the chief rays at the margins of the incident laser beam can be shaped to be substantially parallel to one another after beam-shaping. In some embodiments, optical devices/components 600, 610, and 620 can each be substantially transparent. For example, optical devices/component 600, 610, and 620 can each have a transparent substrate to allow at least most of the light to pass through.

In some embodiments, beam-shaping component 401 includes a prism array 600 and the beam shaping of the incident laser beam includes refraction. FIG. 6A illustrates an exemplary prism array 600, according to embodiments of the present disclosure. Prism array 600 can include a suitable material that allows laser to pass through. For example, prism array 600 can include crown glass (e.g., BK7 glass.) In an example, prism array 600 can include a beam-shaping portion over a transparent substrate, where the beam-shaping portion includes arrays of wedges distributed on the input surface of prism array 600. As shown in FIG. 6A, prism array 600 can include an input surface 601 and an output surface 602. The wedge angle is denoted as a. The surface normal of input surface is denoted as N. The refractive index of prism array 600 is denoted as n. Wedge angle α can be determined as follows. When an incident laser beam 603 (e.g., similar to or the same as first combined laser beam 404) is incident on input surface 601 at an incident angle β (i.e., the angle between incident laser beam 603 and surface normal N), wedge angle α can be calculated to be β/(n−1). A shaped laser beam 604 (e.g., similar to or the same as second combined laser beam 406) can exit from output surface 602. Shaped laser beam 604 can be perpendicular to output surface 602 or parallel to the optical axis (e.g., the x axis.) Chief rays in shaped laser beam 604 can be parallel to one another. In an example, when incident angle β is 0.43° and prism array 600 contains BK7 glass (n≈1.51), α is about 0.84°. A length L_{P} of substrate of prism array 600 along the z axis may be in a range of about 3.0 mm to about 5.0 mm, a width W_{P} of substrate of prism array 600 along the x axis may be in a range of about 0.5 mm to about 1.5 mm, and a thickness T_{P} of array of prism array 600 along the x axis may be in a range of about 0.005 mm to about 0.015 mm. In some embodiments, length L_{P} of substrate of prism array 600 along the z axis is about 4.0 mm, width W_{P} of substrate of prism array 600 along the x axis is about 1.0 mm, and thickness T_{P} of array of prism array 600 along the x axis is about 0.01 mm.

In some embodiments, beam-shaping component 401 includes a diffractive optical element (DOE), and the beam shaping includes diffraction. FIGS. 6B and 6C illustrate exemplary DOEs 610 and 620, according to embodiments of the present disclosure. DOEs 610 and 620 can each include a beam-shaping portion over a transparent substrate, where the beam-shaping portion includes a plurality of diffraction gratings distributed on the input surface. When an incident laser beam (e.g., similar to or the same as first combined laser beam 404) is incident on the input surface of the DOE at an incident angle β (i.e., the angle between the incident laser beam and the surface normal of the input surface), period d of the DOE represents the spacing between repeating units can be calculated as mλ/sin(β), where m (e.g., an integer) represents diffraction order and K represents the wavelength of the incident laser beam. A shaped laser beam (e.g., similar to or the same as second combined laser beam 406) can exit from the output surface of DOE. The shaped laser beam can be perpendicular to output surface or parallel to the optical axis (e.g., the x axis.) Chief rays of the shaped laser beam can be parallel to one another. In an example, when incident angle β is 0.43°, diffraction order is 1, and wavelength is 905 nm, period d is about 120.6 μm. In some embodiments, to increase diffraction efficiency, multi-level DOE and/or continuous DOE are used. The multi-level DOE and continuous DOE can linearly change the phase of the incident laser beam from 0 to 2π in each period d, and diffusion efficiency can be increased at a desired diffraction order and decreased at other undesired diffraction orders. For example, diffraction efficiency can be the highest at m=1, and lowest at all other m values. FIG. 6B illustrates a multi-level DOE and FIG. 6C illustrates a continuous DOE (e.g., blazed gratings). The multi-level DOE and the continuous DOE can have the same grating period and can include a suitable material of sufficiently high transmission rate such as crown glass (e.g., BK7 glass.)

As shown in FIG. 6B, DOE 610 includes an input surface 605 and an output surface 606, where an incident laser beam 607 is incident on input surface 605 and a shaped laser beam 608 exits from output surface 606. The surface normal of input surface is denoted as N. Diffraction gratings (e.g., multi-level steps) can be distributed on input surface 605 and have a period of d. Period d can be the spacing between the centers of adjacent periods. A length L_{G} of substrate of DOE 610 along the z axis may be in a range of about 0.2 mm to about 5 mm, a width W_{G} of substrate of DOE 610 along the x axis may be in a range of about 0.1 mm to about 3 mm, a thickness T_{G} of gratings in one period d of DOE 610 along the x axis may be in a range of about 0.1 μm to about 100 μm, and a number of steps in one period d is about 2 to about 16. In some embodiments, length L_{G} of substrate of DOE 610 along the z axis is about 3 mm, width W_{G} of substrate of DOE 610 along the x axis is about 1.0 mm, thickness T_{G} of gratings in one period d of DOE 610 along the x axis is about 0.6 μm, and the number of steps in one period d is about 16.

As shown in FIG. 6C, DOE 620 includes an input surface 605′ and an output surface 606′, where incident laser beam 607′ is incident on input surface 605′ and a shaped laser beam 608′ exits from output surface 606′. The surface normal of input surface is denoted as N′. Diffraction gratings (e.g., continuous DOE) can be distributed on input surface 605′ and have a period of d′. Period d′ can be the spacing between the centers of adjacent periods. A length L_{G}′ of substrate of DOE 620 along the z axis may be in a range of about 0.2 mm to about 5 mm, a width W_{G}′ of substrate of DOE 620 along the x axis may be in a range of about 0.2 mm to about 3 mm, a thickness T_{G}′ of gratings in one period d of DOE 620 along the x axis may be in a range of about 0.1 μm to about 100 μm, and the blazed angle is in a range of about 0.2 degrees to about 0.6 degrees. In some embodiments, length L_{G}′ of substrate of DOE 620 along the z axis is about 2 mm, width W_{G}′ of substrate of DOE 620 along the x axis is about 1.0 mm, thickness T_{G}′ of gratings in one period d of DOE 620 along the x axis is about 0.6 mm, and blazed angle is about 0.4 degrees.

In some embodiments, beam-shaping component 401 includes a phase plate, and the beam shaping includes changing the phase of the incident laser beam. FIG. 6C illustrates an exemplary phase plate 630 according to the embodiments of the present disclosure. Phase plate 630 can allow the phase of the incident laser beam to vary linearly along the z axis. As shown in FIG. 6D, phase plate 630 can include an input surface 609 and an output surface 610. The surface normal of input surface is denoted as N. The width of phase plate 630 along the optical axis (e.g., the x axis) is denoted as d_{P}. The refractive index of phase plate can vary along the z axis and is denoted as n(z). The wavelength of the incident laser beam is λ. When an incident laser beam 611 (e.g., similar to or the same as first combined laser beam 404) is incident on input surface 609 at an incident angle β (i.e., the angle between incident laser beam 611 and surface normal N), the phase change of the incident laser beam along the z axis can be calculated as Δphase(z)=2π(−kz)/λ=2πΔn(z)d/λ, and k=sin(β). A shaped laser beam 612 (e.g., similar to or the same as second combined laser beam 406) can exit from output surface 610. Shaped laser beam 612 can be perpendicular to output surface 610 or parallel to the optical axis (e.g., the x axis.) Chief rays in shaped laser beam 612 can be parallel to one another. In an example, when incident angle β is 0.43° and a width of phase plate 630 along the optical axis is about 3 mm, Δn(z)=−sin(β)z/d=−2.5e-3z. Thus, phase plate 630 can include a suitable material of sufficiently high transmission rate and having a gradient in refractive index along the z axis. For example, phase plate 630 can include crown glass (e.g., BK7 glass) doped with ion. The dopant ion can form a gradient in refractive index n(z) of phase plate 630. In some embodiments, refractive index n(z) of phase plate 630 increases or decreases along the z axis, depending on incident angle β. A length L_{PP} of phase plate 630 along the z axis may be in a range of about 0.2 mm to about 5.0 mm, width d_{P} of phase plate 630 along the x axis may be in a range of about 0.5 mm to about 5 mm. In some embodiments, length L_{PP} of phase plate 630 along the z axis is about 4.0 mm, and width d_{P} of phase plate 630 along the x axis is about 3 mm.

In some embodiments, collimator 403 is optional. Beam-shaping component 401 can modulate native laser beams 407 to obtain shaped laser beams of chief arrays substantially parallel to one another.

Referring back to FIG. 2, scanner 210 may be configured to emit combined laser beam 209 to an object 212 in a first direction. Scanner 210 may scan object 212 using combined laser beam 209 combined and shaped by light modulator 208, which has minimized gaps between the light, within a scan angle at a scan rate. Object 212 may be made of a wide range of materials including, for example, non-metallic objects, rocks, rain, chemical compounds, aerosols, clouds and even single molecules. The wavelength of combined laser beam 209 may vary based on the composition of object 212. At each time point during the scan, scanner 210 may emit combined laser beam 209 to object 212 in a direction within the scan angle. In some embodiments of the present disclosure, scanner 210 may also include optical components (e.g., lenses, mirrors) that can focus pulsed laser light into a narrow laser beam to increase the scan resolution and range of object 212.

As part of LiDAR system 102, receiver 204 may be configured to detect a returned laser beam 211 returned from object 212 in a different direction. Receiver 204 can collect laser beams returned from object 212 and output electrical signal reflecting the intensity of the returned laser beams. Upon contact, laser light can be reflected by object 212 via backscattering, such as Rayleigh scattering, Mie scattering, Raman scattering, and fluorescence. As illustrated in FIG. 2, receiver 204 may include a lens 214 and a photodetector 216. Lens 214 be configured to collect light from a respective direction in its field of view (FOV). At each time point during the scan, returned laser beam 211 may be collected by lens 214. Returned laser beam 211 may be returned from object 212 and have the same wavelength as combined laser beam 209.

Photodetector 216 may be configured to detect returned laser beam 211 returned from object 212. Photodetector 216 may convert the laser light (e.g., returned laser beam 211) collected by lens 214 into an electrical signal 218 (e.g., a current or a voltage signal). The current is generated when photons are absorbed in the photodiode. In some embodiments of the present disclosure, photodetector 216 may include silicon PIN photodiodes that utilize the photovoltaic effect to convert optical power into an electrical current.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A transmitter for light detection and ranging (LiDAR), comprising:
a laser source configured to provide a plurality of native laser beams; and
a light modulator configured to receive and modulate the plurality of native laser beams to form an output laser beam comprising a plurality of modulated laser beams each having a chief ray, wherein a first set of the chief rays on margins of the output laser beam are parallel to one another along an optical axis.

2. The transmitter of claim 1, wherein the light modulator comprises a beam-shaping component configured to shape an incident laser beam formed based on the plurality of native laser beams such that the first set of chief rays on the margins of the output laser beam are parallel to one another.

3. The transmitter of claim 2, wherein the light modulator further comprises a collimator configured to receive and collimate the plurality of native laser beams to form a plurality of collimated laser beams that form the incident laser beam, and wherein the incident laser beam is received and shaped by the beam-shaping component.

4. The transmitter of claim 3, wherein the beam-shaping component is further configured to redistribute irradiation and phase of the plurality of collimated laser beams based on at least one of a distance between the beam-shaping component and the collimator, a beam size of one of the plurality of the collimated laser beam at a location of the beam-shaping component, and an incident direction of the incident laser beam.

5. The transmitter of claim 4, wherein a second set of chief rays other than the first set of chief rays on the margins of the output laser beam are parallel to the first set of chief rays.

6. The transmitter of claim 4, wherein the laser source comprises a multi-junction pulsed laser diode (PLD) comprising a plurality of light-emitting regions and a plurality of gaps interleaving with the plurality of light-emitting regions, and wherein the plurality of light-emitting regions are configured to provide the plurality of native laser beams.

7. The transmitter of claim 6, wherein chief rays of at least two of the plurality of collimated laser beams on margins of the incident laser beam are non-parallel to one another.

8. The transmitter of claim 7, wherein the multi-junction PLD comprises at least three light-emitting regions, each of the at least three light-emitting regions providing one of the plurality of native laser beams.

9. The transmitter of claim 5, wherein the beam-shaping component comprises one or more of a prism array, a diffractive optical element (DOE), and a phase plate, each comprising an input surface configured to receive the collimated laser beams and an output surface configured to output the output laser beam.

10. The transmitter of claim 9, wherein a wedge angle of the prism array is determined based on one or more of the incident direction of the incident laser beam and a refractive index of the prism array.

11. The transmitter of claim 10, wherein a length of the substrate of the prism array is in a range of about 3.0 mm to about 5.0 mm, a width of the substrate of the prism array is about 0.5 mm to about 1.5 mm, a thickness of the array of the prism array is about 0.005 mm to about 0.015 mm, and a refractive index of the prism array is about 1.51.

12. The transmitter of claim 9, wherein a period of the DOE is determined based on one or more of the incident direction of the incident laser beam and a wavelength of the incident laser beam.

13. The transmitter of claim 12, wherein the DOE comprises one or more of multi-level gratings and continuous gratings.

14. The transmitter of claim 9, wherein a refractive index of the phase plate comprises a gradient along a direction perpendicular to the optical axis, and the gradient is determined based on one or more of the incident direction of the incident beam and a thickness of the phase plate along the optical axis.

15. A transmitter for light detection and ranging (LiDAR), comprising:
a multi-junction pulsed laser diode (PLD) configured to provide a first native laser beam in a first incident direction and a second native laser beam in a second incident direction different from the first incident direction; and
a light modulator comprising a beam-shaping component that comprises:
a transparent substrate; and
a light-shaping portion over the transparent substrate and configured to selectively shape the first native laser beam and the second native laser beam and form a combined laser beam that includes chief laser beams from the first native laser beam and the second native laser beam, wherein the chief laser beams are parallel to one another.

16. The transmitter of claim 15, wherein the light modulator further comprises a collimator located away from the beam-shaping component configured for receiving and collimating the first native laser beam and the second native laser beam to form a first collimated laser beam and a second collimated laser beam, and wherein the first collimated laser beam and the second collimated laser beam are received and shaped by the beam-shaping component.

17. The transmitter of claim 16, wherein the light-shaping portion is configured to selectively shape the first native laser beam and the second native laser beam based on a beam size of the at least one of the first collimated laser beam and the second collimated laser beam and a distance between the collimator and the beam-shaping component.

18. A transmitter for light detection and ranging (LiDAR), comprising:
at least three light-emitting regions in a multi-junction pulsed laser diode (PLD), each of the at least three light-emitting regions configured to provide a respective native laser beam in a respective incident direction; and
a light modulator comprising a beam-shaping component comprising:
a transparent substrate; and
a light-shaping portion over the transparent substrate and configured to selectively shape the at least three native laser beam and form a combined laser beam that includes chief laser beams from the at least three native laser beams, wherein the chief laser beams are parallel to one another.

19. The transmitter of claim 18, wherein the light modulator further comprises a collimator located away from the beam-shaping component configured for receiving and collimating the at least three native laser beams to form at least three collimated laser beams that are received and shaped by the beam-shaping component.

20. The transmitter of claim 19, wherein the light-shaping portion is configured to selectively shape the at least three native laser beams based on a beam size of the at least one of the at least three collimated laser beams and a distance between the collimator and the beam-shaping component.
